(19) United States
(12) Patent Application Publication
(10) Pub. No.: US 2007/0000709 A1
(43) Pub. Date: Jan. 4, 2007

(54) DASHBOARD FOR A MOTOR VEHICLE, AND MOTOR VEHICLE EQUIPPED WITH SUCH A DASHBOARD

(75) Inventors: ELISABETH DANGER, Paderborn (DE); Martin Pohl, Bielefeld (DE); Andreas Hitz, Erwitte (DE); Andreas Wille, Paderborn (DE)

Correspondence Address: HENRY M FEIEREISEN, LLC, 350 FIFTH AVENUE, SUITE 4714, NEW YORK, NY, 10118, US

(73) Assignee: Benteler Automobiltechnik GmbH, Paderborn (DE)

(21) Appl. No.: 11/426,656

(22) Filed: Jun. 27, 2006

(30) Foreign Application Priority Data
Jun. 30, 2005 (DE) 10 2005 030 934.8

(51) Int. Cl. B60K 28/00; G08B 23/00; B62D 25/14

(52) U.S. Cl. 180/272; 340/576; 180/90

(57) ABSTRACT

A dashboard for a motor vehicle includes a support beam extending between windshield pillars of a motor vehicle body, and an active arrangement which interacts with the support beam for vibration damping. The active arrangement includes plural actuators which are disposed on the support beam and a controller which is operatively connected to the actuators. Further provided is an alert system for recognizing a fatigue state of a driver, with the actuators operatively connected to the alert system via the controller.

### CROSS-REFERENCES TO RELATED APPLICATIONS

This application claims the priority of German Patent Application, Serial No. 10 2005 030 934.8, filed Jun. 30, 2005, pursuant to 35 U.S.C. 119(a)-(d), the content of which is incorporated herein by reference.

### BACKGROUND OF THE INVENTION

The present invention relates to a dashboard for a motor vehicle and to a motor vehicle equipped with such a dash board.

Nothing in the following discussion of the state of the art is to be construed as an admission of prior art.

A dashboard includes typically a support beam, e.g. a tube, which is placed between the windshield pillars, as shown, for example, in German Pat. No. DE 196 20 919 A1. German Pat. No. DE 195 34 568 A1 describes a dashboard in the form of a rigid hollow support beam. In the area of the cockpit, various mountings are provided on the dashboard for retaining the instrument panel as well as further vehicle components, such as vehicle heating, ventilating and air conditioning system, airbag, steering column, center console, fuse box or glove compartment. The dashboard is intended to satisfy several functions. Apart from reinforcing the vehicle body, the dashboard support should be able to absorb energy in the event of a collision, to connect various spatial points and to allow attachment of various mountings. In addition, the dashboard support should be suitable for operation in different frequency ranges.

To date, the cross section as well as the wall thickness of a dashboard is sized according to the first resonant frequency. Still, the dashboard oscillates during operation of the vehicle so that vibrations and/or structure-borne sound is generated, adversely affecting the acoustics inside the motor vehicle as well as the running behavior and riding comfort for the passengers. Attempts were made to fixate or to constructively optimize the resonant frequencies, by providing a mounting on the dashboard for attachment of the dashboard to the vehicle body.

German Pat. No. DE 101 12 738 C1 describes the provision of a vibration damping system which is associated to a support beam of a dashboard and includes adaptive piezoelectric elements. Interfering vibrations are picked up by sensors and superimposed with compensation vibrations by a controller in cooperation with the piezoelectric elements.

German Pat. No. 102 11 946 C1 discloses a control element or switching element that is provided with elements which electrically or chemically respond to the sense of touch, for example in a steering wheel. The elements are used for supplying the driver who touches the elements with warnings and/or information about the state of the vehicle or traffic.

It would be desirable and advantageous to provide an improved dashboard for use in a motor vehicle to obviate prior art shortcomings and to improve the riding comfort and riding safety.

### SUMMARY OF THE INVENTION

According to one aspect of the present invention, a dashboard for a motor vehicle includes a support beam extending between windshield pillars of a motor vehicle body, an active arrangement which interacts with the support beam for vibration damping and includes plural actuators disposed on the support beam and a controller operatively connected to the actuators, and an alert system for recognizing a fatigue state of a driver, wherein the actuators are operatively connected to the alert system via the controller.

The present invention resolves prior art problems by coupling the actuators of the vibration damping arrangement via the controller with the fatigue alert system to thereby integrate the vibration damping system with a system to warn the driver of possible dangers, caused e.g. when the driver tires. This integration of the two systems saves space and weight.

When the alert system detects fatigue of the driver, the controller prompts the driver by causing the actuators to vibrate intensely, thereby causing also the dashboard to vibrate at the same time. The alert system may also be constructed to stimulate the driver continuously or randomly via the controller and the actuators, when the driver finds himself in a tedious situation so as to eliminate the presence of possible danger.

The alert system may be constructed to monitor the physiological state of the driver and to detect when defined physical limits have been reached or surpassed during travel. Examples of physiological states that may be used for determining the fatigue state of the driver include eye movement, blinking frequency, muscle tension, and breathing frequency of the driver. Examples of physical limits during driving include distance to objects outside the vehicle, relative position of the vehicle on the roadway, and duration of traveling at constant speed or in same direction.

The active arrangement for vibration damping detects sensory vibrations of the dashboard during travel and damps these vibrations through generation of a compensation vibration. As a result vibrations are quasi neutralized or shifted into another, in particular higher, frequency range.

The active arrangement intervenes actively and induces periodic deformation amplitudes and voltage amplitudes to effectively obliterate vibration or to dampen the frequency in suitable phase position. In addition, the active arrangement is able to decouple interconnected components so as to effectively promote vibration damping. A transmission of vibrations or force flux in the attachment area of adjacent components is avoided.

The actuators may be constructed in the form of actuator/sensor elements which may be configured as fiber composite having embedded therein piezo-ceramic fibers and/or films. In particular thin piezo-ceramic plate elements, also called piezoelectric films, are suitable for integration in the fiber composites, as are piezoelectric ceramic fibers. Examples of piezo-electric ceramic actuators include ceramic mixtures of lead, zirconate and titanate with high electromechanical activity, i.e. great relative length/thickness change when electric voltage is applied Piezo-electric ceramic actuators may also be configured as staple actuators.

The effect of the system according to the present invention is thus based on the utilization of a vibration damping arrangement for generating vibrations that can be perceived intuitively as warning by the driver, and, if desired, also by the passenger. Of course, this system according to the present invention can also be used for retrofitting exiting dashboards or motor vehicles.

According to another feature of the present invention, the actuators may be arranged in an attachment area of a steering wheel to the support beam.

According to another feature of the present invention, the alert system for recognizing a fatigue state of a driver may include at least one camera. The camera may be pointed toward the face of the driver and constructed to monitor in particular an eye movement of the driver. Relevant physiological characteristics that indicate fatigue include a change in the blinking frequency or delayed movements of the eyeballs. It is conceivable to check the fatigue state of the driver by additional stimulations in the form of triggered light excitations. These light excitations may be triggered also below the active perception threshold of a human.

According to another feature of the present invention, the alert system may include at least one sensor for ascertaining a position of a side border marking of a roadway in relation to the motor vehicle. The detection may be implemented optically by cameras in the range of the visible or infrared light spectrum as well as by radio transmission. Respective marking transmitters and transponders may be buried in the roadway. As a result, changes in the relative position of the roadway border markings can be registered. Should the vehicle cross a side border, the driver is prompted by a respective information or warning.

According to another feature of the present invention, the alert system may include at least one sensor for ascertaining a muscle tension of the driver. The sensor or sensors may be arranged on the steering wheel and constructed to determine a pressure by which the driver clings to the steering wheel. A change in the gripping pressure can then indicate fatigue which is then detected.

According to another feature of the present invention, the alert system may include at least one pushbutton which is actuated periodically or deliberately by the driver. The pushbutton may be constructed as dead-man's button and can be disposed on the steering wheel or may be configured as pedal. Another option may involve a pushbutton positioned for actuation by a knee of the driver.

According to another feature of the present invention, a vibration generator may be provided for interacting with a driver's seat and operatively connected to the alert system. In this way, the driver can be warned in situations in which the driver does not hold the steering wheel so that vibrations of the dashboard cannot be perceived.

According to another feature of the present invention, an acoustic or optic alarm may be operatively connected to the alert system. Triggering respective light stimulations or perceivable warning signals can thus further enhance safety during travel.

### BRIEF DESCRIPTION OF THE DRAWING

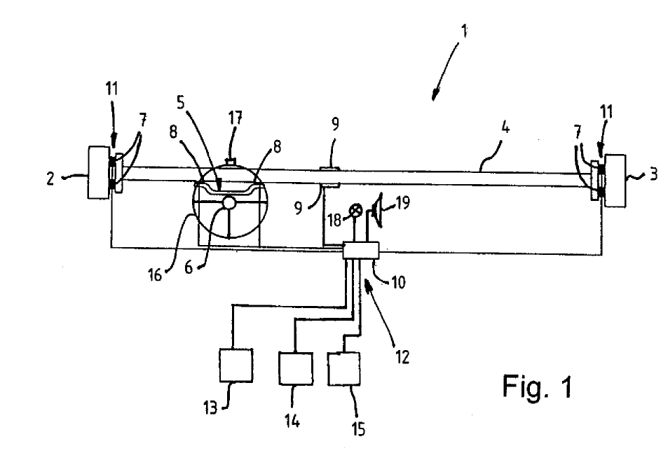

Other features and advantages of the present invention will be more readily apparent upon reading the following description of currently preferred exemplified embodiments of the invention with reference to the accompanying drawing, in which the sole FIG. 1 is a schematic illustration of a dashboard according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views In certain instances, details which are not necessary for an understanding of the present invention or which render other details difficult to perceive may have been omitted.

Turning now to FIG. 1, there is shown a schematic illustration of a dashboard according to the present invention, generally designated by reference numeral 1 and extending between windshield pillars 2, 3, hinted here only, of a motor vehicle body in a direction transversely to the traveling direction of the vehicle. The connection of the dashboard 1 to the windshield pillars 2, 3 is not shown in detail but may be realized in any manner known to the artisan. The dashboard support 1 includes a hollow support beam 4 for carrying the dashboard or instrument panel (not shown) and is intended for attachment and securement of various vehicle components such as vehicle heater, ventilating and air conditioning system, airbag, steering column, denoted in FIG. 1 by reference numeral 6, center console, fuse box or glove compartment. The attachment of the steering column 6 is indicted in FIG. 1 by reference numeral 5.

Associated to the support beam 4 is an active arrangement for vibration damping. The active arrangement includes actuators in the form of piezoelectric elements 7, 8, 9 which are operatively connected to a controller 10 and combine a sensor and an actuator in a unitary structure. The controller 10 is positioned externally in the motor vehicle. Structure and manner of operation of piezoelectric elements, involved here, is generally known to the artisan so that a detailed description is omitted for the sake of simplicity. Persons skilled in the art will also understand that the active arrangement must contain additional apparatus which does not appear in the foregoing Figures, e.g. a power source for supply of voltage, typically a 12 voltage or 24 voltage power source. For the sake of simplicity, this apparatus, or other components that may be provided, have been omitted from the Figures.

As shown in FIG. 1, the piezoelectric elements 7 are disposed in an attachment zone 11 between the windshield pillars 2, 3 and the support beam 4, whereas the piezoelectric elements 8 are disposed between the attachment 5 of the steering column 6 and the support beam 4. The piezoelectric elements 9 are positioned on the support beam 4, e.g. through gluing.

The active vibration damping arrangement is combined with an alert system 12 for recognizing a fatigue state of a driver. The alert system 12 includes a camera 13 which is focused onto the eyes of the driver. In response to a detected change in the blinking frequency, which would indicate fatigue, the alert system 12 sends a respective information signal to the controller 10 which then causes the adaptive piezoelectric elements 7, 8, 9 to vibrate the support beam 4 in dependence on the degree of danger. These vibrations are felt by the driver intuitively and interpreted as information or warning as it stimulates the driver's sense of touch. A radiator which generates light pulses is not shown in greater detail can be used to test the fatigue of the driver through targeted stimulations.

The alert system 12 further includes one or more cameras 14 disposed on the side of the motor vehicle for detecting the position of roadway borders in relation to the vehicle. Typically, the roadway has a black or dark-gray road surface and is marked with white or yellow lines as border on the road surface so as to produce an image that is rich in contrast. When the vehicle crosses the side markings, a respective warning signal is triggered. In addition, the alert system 12 includes distance sensors 15 on all sides of the vehicle for detecting a distance of the vehicle from external objects, such as other vehicles, pedestrians, or posts, for example.

Connected to the steering column 6 is a steering wheel 16 which has attached thereto pressure sensors 17 for detecting a pressure by which the driver clings to the steering wheel 16. The pressure sensors 17 are further used as dead-man's button. An indicator 18 in proximity of or on the windshield is provided to prompt the driver to change for a short time the pressure by which the driver's hand grips the steering wheel 16. A loudspeaker 19 mounted to or in proximity of the support beam 4 provides an additional acoustic prompt signal. The pressure sensors 17, the indicator 18, and the loudspeaker 19 are all operatively connected to the controller 10.

Although not shown in detail, a vibration generator may be disposed underneath the seat cushion of a drivers seat and operatively connected to the alert system 12.

The indicator 18 and the loudspeaker 19 may, of course, also be connected via the controller 10 to the alert system 12 for generating other warning signals or to other systems of the motor vehicle.

A dashboard 1 according to the invention and a motor vehicle equipped with a dashboard 1 according to the invention integrates a system for vibration damping with a system for alerting a driver of fatigue. As a result of such an integrated combination of systems, installation space and weight can be saved and in addition safety, performance and comfort of the motor vehicle can be enhanced.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A dashboard for a motor vehicle, comprising:
a support beam extending between windshield pillars of a motor vehicle body;
an active arrangement which interacts with the support beam for vibration damping and includes plural actuators which are disposed on the support beam and a controller which is operatively connected to the actuators; and
an alert system for recognizing a fatigue state of a driver,
wherein the actuators are operatively connected to the alert system via the controller.

2. The dashboard of claim 1, wherein the actuators are arranged in an attachment area of a steering wheel to the support beam.

3. The dashboard of claim 1, wherein the alert system is rendered operative to send a signal to the controller when the fatigue state of the driver reaches a predetermined level, to thereby cause the controller to activate the actuators and to vibrate the actuators.

4. The dashboard of claim 1, wherein the alert system is constructed to send a continuous signal to the controller to thereby cause the controller to activate the actuators and to vibrate the actuators for keeping the driver alert.

5. The dashboard of claim 1, wherein the alert system is constructed to send a signal at random sequence to the controller to thereby cause the controller to activate the actuators and to vibrate the actuators for keeping the driver alert.

6. A motor vehicle, comprising:
a steering column;
spaced-apart windshield pillars; and
a dashboard having a support beam extending between the windshield pillars, an active arrangement which interacts with the support beam for vibration damping and includes plural actuators which are disposed on the support beam and/or steering column, a controller which is operatively connected to the actuators, and an alert system for recognizing a fatigue state of a driver, wherein the actuators are operatively connected to the alert system via the controller.

7. The motor vehicle of claim 6, wherein the alert system includes at least one camera.

8. The motor vehicle of claim 7, wherein the camera traces a movement of the eyes of the driver.

9. The motor vehicle of claim 6, wherein the alert system includes at least one sensor for ascertaining a position of a side border marking of a roadway in relation to the motor vehicle.

10. The motor vehicle of claim 6, wherein the alert system includes a distance sensor to ascertain a lateral distance of the motor vehicle from an external object.

11. The motor vehicle of claim 6, wherein the alert system includes at least one sensor for ascertaining a muscle tension of the driver.

12. The motor vehicle of claim 11, further comprising a steering wheel mounted to the steering column, wherein the sensor is disposed on the steering wheel and constructed to determine a pressure by which the driver grips the steering wheel.

13. The motor vehicle of claim 6, wherein the alert system includes at least one pushbutton which is actuated periodically or deliberately by the driver.

14. The motor vehicle of claim 13, further comprising a steering wheel mounted to the steering column, wherein the pushbutton is disposed on the steering wheel.

15. The motor vehicle of claim 13, wherein the pushbutton is a pedal.

16. The motor vehicle of claim 13, wherein the pushbutton is positioned for actuation by a knee of the driver.

17. The motor vehicle of claim 6, further comprising a vibration generator interacting with a driver's seat and operatively connected to the alert system.

18. The motor vehicle of claim 6, further comprising an optic alarm operatively connected to the alert system.

19. The motor vehicle of claim 6, further comprising an acoustic alarm operatively connected to the alert system.

20. A combined comfort-enhancing and warning system for a motor vehicle, comprising:
an active arrangement mounted to a support beam of a dashboard for damping vibration of the dashboard, said active arrangement including plural actuators which are disposed on the support beam, and a controller which is operatively connected to the actuators; and
an alert system operatively connected to the controller for recognizing a fatigue state of a driver and prompting the driver when a fatigue state is determined, whereby the controller activates the actuators to cause vibration of the dashboard when the alert system detects fatigue of the driver.
